(19) United States
(12) Patent Application Publication
(10) Pub. No.: US 2024/0253208 A1
(43) Pub. Date: Aug. 1, 2024

(54) EXOSKELETON ARM AID IN AIRCRAFT COCKPIT FOR HIGH ACCELERATIONS

(71) Applicant: Deutsches Zentrum für Luft- und Raumfahrt e.V., Bonn (DE)

(72) Inventor: Florian Wolz, Estenfeld (DE)

(21) Appl. No.: 18/425,375

(22) Filed: Jan. 29, 2024

(30) Foreign Application Priority Data
Feb. 1, 2023 (DE) 10 2023 102 424.8

(51) Int. Cl. B25J 9/00; B64D 11/00

(52) U.S. Cl. CPC B25J 9/0006; B64D 11/00

(57) ABSTRACT

A system to assist an occupant of an aircraft during cockpit operation under high accelerations, wherein the system includes an exoskeleton arm including a plurality of joints, actuators, and bearing surfaces to support an arm of the occupant, an inertial measuring unit configured to detect kinematic data of the aircraft and transmit the kinematic data, a computing unit configured to receive the kinematic data transmitted from the inertial measuring unit, to determine an acceleration at the occupant's seat from the kinematic data, and to control the actuators of the exoskeleton arm to generate a counterforce directed against the acceleration at the occupant's seat in an amount that compensates for inertial forces of the occupant's arm due to the acceleration at the occupant's seat.

### CROSS-REFERENCE TO RELATED APPLICATIONS

This application claims benefit of German Patent Application No. 10 2023 102 424.8, filed on 1 Feb. 2023, the contents of which are incorporated herein by reference in their entirety.

### BACKGROUND

### Field

The invention relates to a system for assisting an occupant of an aircraft when operating the cockpit under high accelerations, and an aircraft having such a system.

### Related Art

In manned flight control, a pilot typically has access to controls for controlling subsystems of their aircraft. Such controls relate to communication, navigation, lights, and more, depending on the aircraft type. For flight control itself, i.e., to influence an aircraft state using components for torque dynamics (roll movement, pitch movement, yaw movement) and components for translational accelerations and speeds, appropriate controls are available depending on the configuration of the aircraft. In fixed-wing aircraft, such controls typically comprise a joystick for controlling pitch and roll movements, as well as one or more thrust levers for setting a desired thrust lever position correlating with a desired thrust of the aircraft engine(s) of the aircraft, and pedals for controlling a torque about the vertical axis of the aircraft.

Special configurations of manned aircraft often have peculiarities in their degrees of freedom in terms of thrust and aerodynamic control surfaces, which may be reflected in the designs of the controls in the cockpit of the manned aircraft. While in commercial aircraft, e.g., moderate accelerations due to turns, etc., can be assumed, and large and slow-to-operate control horns therefore represent an ergonomic option, in agile combat aircraft accelerations of 9g and more are achieved due to the possibility of flying tight-turn radii at high speeds.

However, the controls mentioned at the beginning are also available in a wide variety depending on the configuration and type of manned aircraft. While historical aircraft were equipped exclusively with analog instruments (displays) and mechanical switches and buttons, modern aircraft are increasingly equipped with digital displays, which can at least partially take on the function of controls by being designed as touchscreens.

In all cases, however, it is challenging for the pilot to read instruments and operate controls correctly during flight, since quasi-static and dynamic accelerations, such as load multiples caused by gusts, vibrations of drives, such as rotors, propellers, internal combustion engines, and the like, make coordination by the pilot or co-pilot difficult.

Especially in particularly agile aircraft, such as combat aircraft (interceptors, multi-purpose combat aircraft, air superiority fighters) or aerobatic aircraft, the pilot is exposed to high accelerations in maneuvers such as so-called dog fights in military jargon. These accelerations are not only directed toward the seat surface area of the pilot's seat, whereby the pilot is pressed into the seat by a multiple of normal gravitational acceleration, but may also be directed away from the pilot's seat due to the pitching of the aircraft. However, high lateral accelerations can also act on the pilot, e.g., when rapidly building up or reducing high roll rates about a longitudinal axis of the aircraft, and in rare cases for special configurations, in principle also in a yaw motion.

Such quasi-static accelerations and vibrations can make manual operation of the cockpit considerably more difficult for the operating elements and controls mentioned at the beginning, such as the joystick and thrust lever, as not only do higher-frequency vibrations have a negative effect on the pilot's eye-hand coordination, but the quasi-static accelerations with a multiple of the acceleration due to gravity also demand considerable muscle work from the pilot in order to compensate for the inertial force of the arms and hands against the acting acceleration. This has a stressful effect on the pilot and is exhausting over a longer period of time. With such high accelerations acting on the pilot's body, voice control is hardly feasible, as clear speech is also made difficult, even to the point of making it impossible to pronounce common phrases. While typically a cockpit designed according to the HOTAS principle (HOTAS is an abbreviation for “hands on throttle and stick”) is known and used in the prior art for these reasons and in order to minimize the reaction time of the pilot when operating the human-machine interface (and therefore without identifying a specific document from the prior art) touchscreens are increasingly utilized as well, due to the high functionality and increasing complexity of military aircraft. Complex operating inputs are also difficult to make according to the HOTAS principle, since there are too few degrees of freedom available through buttons and mini joysticks on the thrust lever and/or joystick, or since these result in cumbersome operation. The anti-G suits for pilots, which are also frequently used in the military, help maintain blood circulation and thus the oxygen supply to the tissue and brain, i.e., vital functions, but cannot reduce the inertial forces acting on the limbs when operating the cockpit. The same applies to the frequently used forced breathing during high accelerations.

### SUMMARY

It is therefore the object of the invention to simplify the manual operation of a cockpit of a manned, highly agile or otherwise high-acceleration aircraft for an occupant, in particular, the pilot or co-pilot.

The invention results from the features of the independent claims. Advantageous further developments and embodiments are the subject matter of the dependent claims.

A first aspect of the invention relates to a system for assisting an occupant of an aircraft during cockpit operation under high accelerations, having a computing unit, an inertial measuring unit, and an exoskeleton arm with a plurality of joints and actuators and bearing surfaces for supporting an arm of the occupant, wherein the inertial measuring unit is configured to record kinematic data of the aircraft and transmit it to the computing unit, wherein the computing unit is configured to determine an acceleration at the pilot's seat from the captured kinematic data of the inertial measuring unit and control the actuators of the exoskeleton arm in order to generate a counterforce directed against the determined acceleration at the pilot's seat in an amount that compensates for the inertial forces of the occupant's arm due to the determined acceleration at the pilot's seat.

In most cases, the occupant is expected to be a pilot. In accordance with the common usage of referring to the pilot as “pilot flying” and the co-pilot as “pilot not flying,” the term pilot refers to both a pilot and a copilot, as well as a weapon systems officer. In fighter aircraft, it is not uncommon for a two-man crew to be seated one behind the other, and in a few cases of fighter aircraft and helicopters, side by side.

The kinematic data of the inertial measuring unit preferably includes accelerations and/or rotation rates of the aircraft. More preferable, the kinematic data of the inertial measuring unit includes both accelerations and rotation rates of the aircraft and more preferable, both translational and rotational accelerations of the aircraft. This is particularly useful when the inertial measuring unit is arranged in the area of an expected center of gravity of the aircraft, i.e., typically at a distance from the pilot's seat at least in the longitudinal direction of the aircraft. If such an arrangement of the inertial measuring unit is used, on the one hand the stationary load multiple of the aircraft in stationary turning flight can be transferred directly to the pilot's seat solely through the translational acceleration (as measured in the inertial measuring unit), but if a pitching movement is also built up in the aircraft, this translational acceleration measured at the center of gravity of the aircraft is not sufficient, since the radius between the inertial measuring unit at or near the center of gravity of the aircraft towards the pilot's seat represents a radius of a circular movement of the pilot's seat around the center of gravity of the aircraft during the rotation of the aircraft. However, by knowing this radius and the rotational movement of the aircraft, it is also possible to draw conclusions about the finally resulting acceleration at the pilot's seat. This is the task of the computing unit. Depending on the angle at which the inertial measuring unit is arranged on the aircraft relative to the rest of the structure of the aircraft and what distance it is from the pilot's seat, different kinematic data are necessary to be able to determine the resulting acceleration vector at the pilot's seat. It is therefore generally referred to as kinematic data, since it depends on the respective situation which specific kinematic data is necessary in order to be able to determine the acceleration vector, since it is determined by all states of motion of the aircraft.

For this purpose, the inertial measuring unit has certain sensors in accordance with the above-mentioned requirements, for example, gyroscopes for determining orientation (i.e., the position angle of the aircraft) and rotation rates, and corresponding acceleration sensors for determining accelerations. If the inertial measuring unit normally installed in the aircraft is used for the purposes of flight control and to obtain information about the current flight status for display on cockpit instruments, it is also used for the stated purposes of determining the acceleration vector at the pilot's seat to determine the counterforce for the exoskeleton arm; these types of sensors are typically installed anyway.

The exoskeleton arm has a variety of actuators and joints. The degrees of freedom and position of the joints are preferably modeled on those of the occupant's human arm. The exoskeleton arm preferably has a shoulder joint, which is configured, for example, as a ball joint and can be rotated about a punctiform bearing point. Furthermore, an elbow joint is preferably provided so that the supported forearm on the exoskeleton arm can also be moved in the degree of freedom of the elbow, so that an angle between the upper arm and forearm can be adjusted. This advantageously allows the occupant a natural movement of his human arm, which is accommodated in the exoskeleton arm, to be able to operate the cockpit of the aircraft in the usual manner, only with the support of the counterforce generated by the actuators of the exoskeleton arm. This counterforce is preferably such in direction and amount that any additional force otherwise required by the occupant to overcome the inertial force acting on his arm, which is caused by flight maneuvers on curved paths, is compensated for in direction and height, and the pilot optionally uses the arms in an artificial weightlessness or against the simple gravitational acceleration.

The actuators are preferably electrical actuators, since these can offer the lightest design in terms of controllability and the necessary torque. To be able to transfer the torque/force of the actuators as a counterforce to the human arm of the occupant, bearing surfaces are provided on the exoskeleton arm, which form contact surfaces between the exoskeleton arm and the human arm. Forces can be transmitted via these contact surfaces; these contact surfaces are preferably appropriately padded, but are still stiff enough to be able to transmit forces in sufficiently high bandwidths.

Alternatively, hydraulic actuators are preferably used, wherein advantageously no separate hydraulic system for generating hydraulic pressure needs to be provided, but instead the existing hydraulic system of the aircraft can be used.

The exoskeleton arm is therefore preferably placed enclosing the human arm of the occupant, and therefore preferably follows the dimensions of the human arm in its geometric contour. While in principle a single exoskeleton arm with the function explained can be installed in an aircraft in order to support a human arm of the occupant during high accelerations of the aircraft such as in fast turning flights, two exoskeleton arms are preferably provided per pilot so that he can operate the cockpit of the aircraft with both arms.

It is a beneficial effect of the invention that the fatigue-free operation and control of an aircraft thus obtained can increase the so-called “situational awareness” and reduce the reaction time of the occupant of the aircraft; fatigue caused by extreme exertion during increased accelerations, especially quasi-static ones, can be reduced, thus increasing the performance and the ability to concentrate on what is going on. By using an actively supporting exoskeleton for the shoulder, upper arms and/or forearms or the hand, the pilot has to apply less force, which means that the pilot is less tired. The system can also be used for spacecraft that take off from Earth. The spacecraft are not aircraft in the strict sense, but should be considered as such within this document, since they can also have high accelerations and fly through it when taking off or landing on Earth after re-entering the Earth's atmosphere.

According to an advantageous embodiment, an inertial arm measuring unit is arranged on the exoskeleton arm and is configured to determine kinematic data of the exoskeleton arm and transmit it to the computing unit, wherein the computing unit is configured to use the kinematic data of the aircraft recorded by the inertial measuring unit as well as from to determine the counterforce from the kinematic data of the exoskeleton arm recorded by the inertial arm measuring unit and to control the actuators of the exoskeleton arm to apply the determined counterforce.

According to this embodiment, both the aircraft inertial measuring unit for determining aircraft-related kinematic data and the inertial arm measuring unit for determining exoskeleton arm-related kinematic data are used together to determine the amount and direction of the counterforce. Preferably, the calculation of the acceleration at the pilot's seat using the aircraft's inertial measuring unit serves as a pilot control signal for the counterforce, while the actually measured acceleration can be used by the inertial arm measuring unit for corrections and a control circuit to correct and specify the pilot control.

Preferably, a first inertial arm measuring unit is arranged in the area of the human upper arm for each exoskeleton arm, and a second inertial arm measuring unit is arranged in the area of the human forearm for each exoskeleton arm. Again, the kinematic data of the inertial arm measuring unit, analogous to the inertial measuring unit of the aircraft, preferably relates to accelerations, in particular translational accelerations. Rotation rates are not necessary for direct measurement of translational accelerations on one or more inertial arm measuring units if sufficient information about locally occurring translational accelerations is available.

According to another advantageous embodiment, the exoskeleton arm has bio-sensors which are configured to determine action potentials of the occupant and transmit them to the computing unit, wherein the computing unit is configured to determine a movement of the exoskeleton arm desired by the occupant based on the action potentials determined by the bio-sensors and to control the actuators superimposed on the counterforce to apply a force and/or a torque to carry out the desired movement of the exoskeleton arm.

These bio-sensors are used, in particular, to determine a desired movement of the occupant at the beginning of the movement and to support the movement with the help of the actuators in such a way that the exoskeleton arm is carried along and is therefore practically no longer noticeable for the occupant. A necessary force or torque from the actuators is then superimposed on the determined counterforce.

According to a further advantageous embodiment, the computing unit is configured to determine a direction in the space of the acceleration occurring at the pilot's seat and to determine the counterforce along this direction and to control the actuators of the exoskeleton arm accordingly. By determining the acceleration as a spatial vector with three components of a Cartesian coordinate system, it is possible to determine and apply a counterforce with spatial orientation as well. Although this increases the complexity of the necessary designs of the actuators and the joints of the exoskeleton arm, it does allow fully supported movement of the human pilot arm.

According to another advantageous embodiment, the system further has an optical tracking system which is configured to detect a current position and/or speed of the exoskeleton arm relative to the cockpit and to transmit it to the computing unit, wherein the computing unit is configured to readjust a movement of the exoskeleton arm and/or the counterforce based on the determined position and/or speed of the exoskeleton arm.

According to another advantageous embodiment, the inertial measuring unit is intended to be arranged in the aircraft at a distance from the pilot's seat along a longitudinal axis of the aircraft, wherein the computing unit is configured to calculate the accelerations at the pilot's seat using the known distance and from the kinematic data of the inertial measuring unit. This component of the finally resulting acceleration at the pilot's seat is determined in particular from the pitch rate of the aircraft and from the lever arm between the pilot's seat and the center of gravity of the aircraft, and further preferably from the derivation of the pitch rate of the aircraft. Superimposed on this component, the translational accelerations that may be caused by turning flight, for example, as well as other accelerations such as a changed rolling movement of the aircraft, must also be taken into account.

According to another advantageous embodiment, the exoskeleton arm has respective bearing surfaces for an upper arm and a forearm adjoining the upper arm.

According to another advantageous embodiment, the exoskeleton arm has joints with degrees of freedom that are configured analogously to the degrees of freedom of the human shoulder and the human elbow, such that the occupant's arm accommodated in the exoskeleton arm can perform all movements possible due to its degrees of freedom in the shoulder and elbow through the exoskeleton arm as well, and the actuators of the exoskeleton arm support all these movements by the counterforce against the determined acceleration.

Another aspect of the invention relates to an aircraft with a system as described above and below.

According to another advantageous embodiment, the aircraft has a first and a second exoskeleton arm, wherein the respective exoskeleton arm is mounted on the aircraft structure at shoulder height behind the backrest of the occupant seat.

Advantages and preferred refinements of the proposed system result from an analogous and corresponding transfer of the statements made above in conjunction with the proposed system.

Further advantages, features, and details will be apparent from the following description, in which-possibly with reference to the drawings—at least one example embodiment is described in detail. The same, similar, and/or functionally identical parts are provided with the same reference numerals.

### BRIEF DESCRIPTION OF THE DRAWINGS

In the drawings:

FIG. 1 shows a system for supporting a pilot of an aircraft in cockpit operation under high accelerations in accordance with an example embodiment of the invention; and

FIG. 2 shows an aircraft with a system according to FIG. 1 in accordance with an example embodiment of the invention.

The illustrations in the figures are schematic and not to scale.

### DETAILED DESCRIPTION

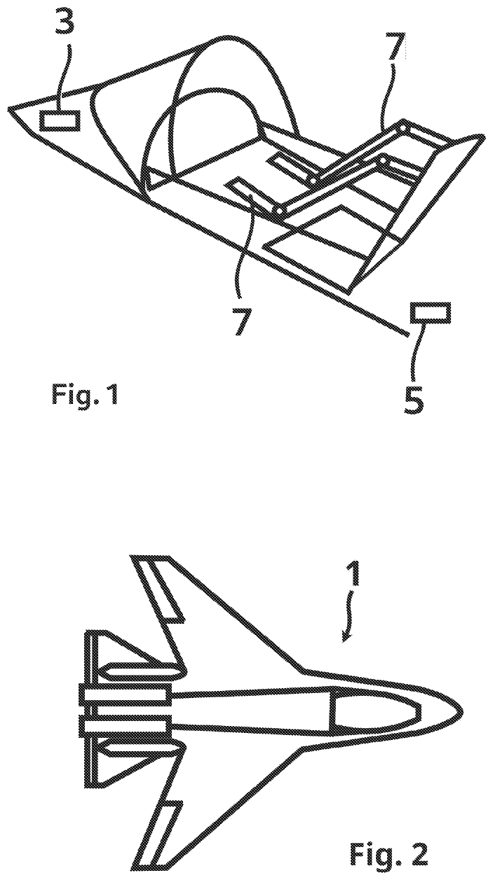

FIG. 1 shows a system for supporting a pilot of a single-seat combat aircraft 1 in cockpit operation under high accelerations. Shown is a cockpit of the aircraft 1 of FIG. 2 with the main direction of flight to the top left in the drawing plane of FIG. 1, wherein the windshield and an instrument board are outlined. The pilot's seat is shown in the lower right of the drawing. The system for supporting the pilot has the following: a computing unit 3, an inertial measuring unit 5, and first and second exoskeleton arms 7, each with a plurality of joints and actuators and bearing surfaces for supporting a respective arm of the pilot. The inertial measuring unit 5 is firmly connected to the aircraft structure and used to determine translational and rotational accelerations, position angles and body-fixed rotation rates of the aircraft 1, each with reference to a point as close as possible to its center of gravity (the center of gravity of the aircraft 1 fundamentally changes depending on refueling and loading). This kinematic data of the aircraft 1 is transmitted to the computing unit 3, which in turn is used to determine an acceleration at the pilot's seat from the detected kinematic data of the aircraft-mounted inertial measuring unit 5, to determine from this acceleration a counterforce dependent on the arm mass of the respective pilot's arm, and to control the actuators of the exoskeleton arm 7 to generate a counterforce against the determined acceleration at the pilot's seat in an amount that compensates for the inertial forces of the pilot's arm due to the determined acceleration at the pilot's seat. The mass of the respective pilot arm can be preset, but preferably adjusted by a mass estimator during flight. A correspondingly fast convergence of the mass estimator algorithm is prerequisite. This can be done using gravity measurement on the ground or dynamically during flight using the kinematic data from the inertial measuring unit 5. Alternatively, the inertial arm measuring units, which are arranged on each of the exoskeleton arms 7, are adjusted accordingly to correct unwanted acceleration due to disturbance variables. These inertial arm measuring units are arranged on the respective exoskeleton arm 7 and used to determine kinematic data in the form of absolute translational accelerations of the exoskeleton arm 7 and in turn to transmit this data to the computing unit 3. The respective exoskeleton arm 7 is mounted on the aircraft structure at shoulder height behind the pilot and has shoulder joints and elbow joints to represent degrees of freedom, which are configured analogously to the degrees of freedom of the human shoulder and the human elbow, such that the pilot's arm accommodated in the exoskeleton arm 7 can perform all movements possible due to its degrees of freedom in the shoulder and elbow through the exoskeleton arm 7 as well, and the actuators of the exoskeleton arm 7 support all these movements by the counterforce against the determined acceleration.

FIG. 2 shows a top view of the aircraft 1 with the system according to FIG. 1.

Although the invention has been further illustrated and described in detail by way of preferred example embodiments, the invention is not limited by the disclosed examples, and other variations can be derived therefrom by a person skilled in the art without departing from the scope of protection of the invention. It is therefore clear that there is a multitude of possible variations. It is also clear that exemplified embodiments are merely examples, which are not to be construed in any way as limiting the scope, applicability, or configuration of the invention. Instead, the foregoing description and description of the figures enable a person skilled in the art to implement the example embodiments, and such skilled person may make various changes knowing the disclosed inventive concept, for example, with respect to the function or arrangement of individual elements mentioned in an example embodiment, without departing from the scope as defined by the claims and their legal equivalents, such as a more extensive explanation in the description.

### LIST OF REFERENCE NUMERALS

1 aircraft
3 computing unit
5 inertial measuring unit
7 exoskeleton arm

1. A system to assist an occupant of an aircraft during cockpit operation under high accelerations, wherein the system comprises:
an exoskeleton arm comprising a plurality of joints, actuators, and bearing surfaces to support an arm of the occupant;
an inertial measuring unit configured to detect kinematic data of the aircraft and to transmit the kinematic data; and
a computing unit configured to:
receive the kinematic data transmitted from the inertial measuring unit;
determine an acceleration at the occupant's seat from the kinematic data; and
control the actuators of the exoskeleton arm to generate a counterforce directed against the acceleration at the occupant's seat in an amount that compensates for inertial forces of the occupant's arm due to the acceleration at the occupant's seat.

2. The system according to claim 1, wherein the system further comprises an inertial arm measuring unit arranged on the exoskeleton arm, the inertial arm measuring unit configured to determine kinematic data of the exoskeleton arm and transmit the kinematic data of the exoskeleton arm to the computing unit, the computing unit being further configured to determine the counterforce from the kinematic data of the aircraft detected by the inertial measuring unit and from the kinematic data of the exoskeleton arm determined by the inertial arm measuring unit, and to control the actuators of the exoskeleton arm in order to apply the counterforce as determined.

3. The system according to claim 1, wherein the exoskeleton arm comprises bio-sensors configured to determine action potentials of the occupant and transmit the action potentials to the computing unit, the computing unit being further configured to determine a movement of the exoskeleton arm desired by the occupant based on the action potentials determined by the bio-sensors, and to control the actuators superimposed on the counterforce in order to apply a force and/or a torque to carry out the movement of the exoskeleton arm desired by the occupant.

4. The system according to claim 1, wherein the computing unit is further configured to determine a spatial direction of the acceleration occurring at the occupants seat, to determine the counterforce along the spatial direction, and to control the actuators of the exoskeleton arm accordingly.

5. The system according to claim 1, wherein the system further comprises an optical tracking system configured to detect a current position and/or a current speed of the exoskeleton arm relative to the cockpit of the aircraft, and to transmit the current position and/or the current speed to the computing unit, the computing unit being further configured to readjust a movement of the exoskeleton arm and/or the counterforce based on the current position and/or the current speed of the exoskeleton arm.

6. The system according to claim 1, wherein the inertial measuring unit is intended to be arranged in the aircraft at a known distance from the occupant's seat along a longitudinal axis of the aircraft, the computing unit being further configured to calculate accelerations at the occupant's seat using the known distance and from the kinematic data of the inertial measuring unit.

7. The system according to claim 1, wherein the exoskeleton arm further comprises respective bearing surfaces for an upper arm and a forearm adjoining the upper arm.

8. The system according to claim 7, wherein the joints of the exoskeleton arm have degrees of freedom configured analogously to degrees of freedom of a human shoulder and a human elbow, such that the occupant's arm accommodated in the exoskeleton arm is capable of performing all movements possible due to its degrees of freedom in the shoulder and the elbow through the exoskeleton arm as well, and the actuators of the exoskeleton arm support all the movements by the counterforce against the acceleration as determined.

9. An aircraft comprising a system according to claim 1.

10. The aircraft according to claim 9, wherein the aircraft comprises a first exoskeleton arm and a second exoskeleton arm, wherein respective exoskeleton arms are mounted on structure of the aircraft structure at shoulder height behind the occupant's seat.
